(19) United States
(12) Patent Application Publication
(10) Pub. No.: US 2023/0214024 A1
(43) Pub. Date: Jul. 6, 2023

(54) IMAGE PROCESSING APPARATUS, IMAGE PROCESSING METHOD, AND NON-TRANSITORY COMPUTER-READABLE MEDIUM

(71) Applicant: NEC Corporation, Minato-ku, Tokyo (JP)

(72) Inventor: Shoji Nishimura, Tokyo (JP)

(73) Assignee: NEC Corporation, Minato-ku, Tokyo (JP)

(21) Appl. No.: 17/927,914

(22) PCT Filed: May 29, 2020
(86) PCT No.: PCT/JP2020/021315

§ 371 Date: Nov. 28, 2022

(51) Int. Cl. G06F 3/01; G06V 20/52; G06V 40/20; G06V 20/40

(52) U.S. Cl. CPC G06F 3/017; G06V 20/52; G06V 40/20; G06V 20/40

(57) ABSTRACT

An image processing apparatus (10) includes an image processing unit and an execution unit. The image processing unit processes a video generated by a surveillance camera (20), and thereby determines whether a person included in the video performs a first gesture. The execution unit executes first processing on a necessary condition that the first gesture is detected. As described above, a plurality of types of the first gestures exist, and the first processing is determined for each of a plurality of types of the first gestures. Then, the execution unit executes the first processing being associated with a type of the detected first gesture.

### TECHNICAL FIELD

The present invention relates to an image processing apparatus, an image processing method, and a program.

### BACKGROUND ART

In recent years, surveillance cameras are placed in various places. One usage of a surveillance camera is to detect an abnormal situation. For example, Patent Document 1 describes that, in a case where an image of a person included in a surveillance image of a surveillance region is a previously registered regular user, an emergency report is made when the person takes a predetermined emergency action.

Note that, Patent Document 2 describes the following. First, in a case where an operator operating a plant is managed by a surveillance camera, a limb body expression that should be performed by the operator when the operator confirms an alarm displayed on a display is previously determined. Then, after the alarm is displayed, the limb body expression performed by the operator is detected by processing a video of the surveillance camera.

### RELATED DOCUMENT

### Patent Document

Patent Document 1: Japanese Patent Application Publication No. 2011-192157

Patent Document 2: Japanese Patent Application Publication No. 2013-190894

### SUMMARY OF THE INVENTION

### Technical Problem

When a gesture input is allowed to be performed to a surveillance camera, a possibility that an action relating to surveillance becomes fast increases. On the other hand, a technique described in Patent Document 1 has a room for enhancing convenience. One object to be solved by the present invention is to enhance convenience when a gesture input is performed to a surveillance camera.

### Solution to Problem

An imaging apparatus according to an example aspect of the present invention includes:

an image processing unit that processes a video generated by a surveillance camera, and thereby determines whether a person included in the video performs a first gesture; and

an execution unit that executes first processing on a necessary condition that the first gesture is detected, wherein

a plurality of types of the first gestures exist,

the first processing is determined for each of a plurality of types of the first gestures, and

the execution unit executes the first processing being associated with a type of the detected first gesture.

An image processing apparatus according to an example aspect of the present invention includes:

an image processing unit that processes a video generated by a surveillance camera, and thereby determines whether a person included in the video performs a first gesture; and

an execution unit that executes first processing on a necessary condition that the first gesture is detected, wherein,

after the first gesture is detected, the image processing unit determines whether the person further performs a second gesture, and,

when the second gesture is detected, the execution unit executes the first processing.

An image processing method according to an example aspect of the present invention includes,

performing by a computer:
image processing of processing a video generated by a surveillance camera, and thereby determining whether a person included in the video performs a first gesture; and
execution processing of executing first processing on a necessary condition that the first gesture is detected, wherein

a plurality of types of the first gestures exist,

the first processing is determined for each of a plurality of types of the first gestures, and,

in the execution processing, the computer executes the first processing being associated with a type of the detected first gesture.

An image processing method according to an example aspect of the present invention includes,

performing by a computer:
image processing of processing a video generated by a surveillance camera, and thereby determining whether a person included in the video performs a first gesture; and
execution processing of executing first processing on a necessary condition that the first gesture is detected, wherein,

in the image processing, after the first gesture is detected, the computer determines whether the person further performs a second gesture, and,

in the execution processing, when the second gesture is detected, the computer executes the first processing.

A program according to an example aspect of the present invention causes a computer to include:

an image processing function of processing a video generated by a surveillance camera, and thereby determining whether a person included in the video performs a first gesture; and

an execution function of executing first processing on a necessary condition that the first gesture is detected, wherein

a plurality of types of the first gestures exist,

the first processing is determined for each of a plurality of types of the first gestures, and

the execution function executes the first processing being associated with a type of the detected first gesture.

A program according to an example aspect of the present invention causes a computer to include:

an image processing function of processing a video generated by a surveillance camera, and thereby determining whether a person included in the video performs a first gesture; and

an execution function of executing first processing on a necessary condition that the first gesture is detected, wherein,

after the first gesture is detected, the image processing function determines whether the person further performs a second gesture, and,

when the second gesture is detected, the execution function executes the first processing.

### Advantageous Effects of Invention

According to the present invention, convenience is enhanced when a gesture input is performed to a surveillance camera.

### BRIEF DESCRIPTION OF THE DRAWINGS

The above-described object, other objects, features, and advantageous effects will become more apparent from a preferred example embodiment described below and the following accompanying drawings.

FIG. 1 is a diagram for describing a usage environment of an image processing apparatus according to a first example embodiment.

FIG. 2 is a diagram illustrating one example of a functional configuration of the image processing apparatus.

FIG. 3 is a diagram illustrating a hardware configuration example of the image processing apparatus.

FIG. 4 is a flowchart illustrating one example of processing performed by the image processing apparatus.

FIG. 5 is a flowchart illustrating one example of processing performed by an image processing apparatus according to a second example embodiment.

FIG. 6 is a flowchart illustrating one example of processing performed by an image processing apparatus in a third example embodiment.

### DESCRIPTION OF EMBODIMENTS

Hereinafter, example embodiments of the present invention are described by use of the drawings. Note that, a similar reference sign is assigned to a similar component in all the drawings, and description thereof is not repeated as appropriate.

### First Example Embodiment

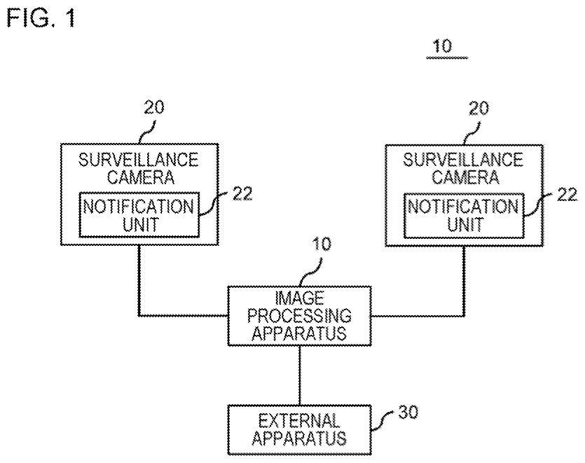

FIG. 1 is a diagram for describing a usage environment of an image processing apparatus 10 according to the present example embodiment. The image processing apparatus 10 processes a video generated by a surveillance camera 20, and thereby performs predetermined processing (hereinafter, referred to as first processing) on a necessary condition that a person included in the video performs a predetermined gesture (hereinafter, referred to as a first gesture). In the present example embodiment, having performed the first gesture is a necessary and sufficient condition. A plurality of types of the first gestures are previously determined. The first processing is determined for each of a plurality of types of the first gestures.

In an example illustrated in the present figure, the image processing apparatus 10 acquires a video from each of a plurality of the surveillance cameras 20. The plurality of the surveillance cameras 20 may capture regions being apart from each other, or may capture regions being adjacent to each other. A frame rate of a video to be generated by the surveillance camera 20 is any frame rate. Places where the surveillance cameras 20 are placed are varied. For example, the surveillance camera 20 may be located within a building, may be located outside a building (e.g., in a city), or may be located within a moving object such as a train, a bus, or an aircraft.

The surveillance camera 20 includes a notification unit 22. The notification unit 22 is at least one of, for example, a speaker, a light emission unit such as lighting, and a display, and is operated by the image processing apparatus 10. The image processing apparatus 10 may change a state of the notification unit 22 as first processing, or may change a state of the notification unit 22, in order to, after first processing is performed, cause a person being present in front of the surveillance camera 20 to recognize that the first processing has been performed.

Note that, examples of a change of a state performed herein are, for example, as follows.

(1) When the notification unit 22 is a speaker, a predetermined sound is continuously output from the speaker for a predetermined time.
(2) When the notification unit 22 is a speaker, an output is changed from the speaker. A target to be changed is at least one of a content meant by a sound, a volume, and a pitch of a sound.
(3) When the notification unit 22 is a display, a predetermined content is started to be displayed on a display.
(4) When the notification unit 22 is a display, displaying of the display is changed.
(5) When the notification unit 22 is a light emission unit, the light emission unit is caused to emit light or flash for a predetermined time.
(6) When the notification unit 22 is a light emission unit, at least one of light emission intensity and a light emission color of the light emission unit is changed.

Note that, the notification unit 22 may be provided outside the surveillance camera 20. In this case, the notification unit 22 is preferably located in a vicinity of the surveillance camera 20. One example of “vicinity” herein is a range where a person seeing the surveillance camera 20 can recognize presence of the notification unit 22.

Moreover, in the present example embodiment, the image processing apparatus 10 communicates with an external apparatus 30. The image processing apparatus 10 performs notification processing for the external apparatus 30 as first processing. A content notified in the notification processing is, for example, occurrence of some abnormality or emergency situation in a capture range of the surveillance camera 20. The external apparatus 30 may be provided in, for example, a security company, or may be provided in a public institution such as police.

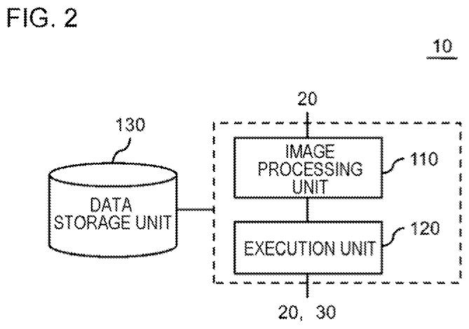

FIG. 2 is a diagram illustrating one example of a functional configuration of the image processing apparatus 10. In the example illustrated in the present figure, the image processing apparatus 10 includes an image processing unit 110 and an execution unit 120.

The image processing unit 110 processes a video generated by the surveillance camera 20, and thereby determines whether a person included in the video performs the first gesture. The image processing unit 110 performs, for example, pose estimation processing for each frame image constituting the video, and detects a gesture to be performed by a person, by use of a result of the pose estimation processing or transition thereof.

The execution unit 120 executes first processing on a necessary condition that the first gesture is detected. As described above, a plurality of types of the first gestures exist, and the first processing is determined for each of a plurality of types of the first gestures. The execution unit 120 executes the first processing being associated with a type of the detected first gesture.

In the example illustrated in the present figure, the image processing apparatus 10 includes a data storage unit 130. The data storage unit 130 stores, for each of a plurality of types of the first gestures, information (e.g., a feature value of a pose of a person in an image, or transition thereof) necessary for detecting the first gesture, and information necessary for performing first processing being associated with the first gesture, in association with each other. The image processing unit 110 detects the first gesture by use of the information stored in the data storage unit 130. The execution unit 120 executes the first processing by use of the information stored in the data storage unit 130.

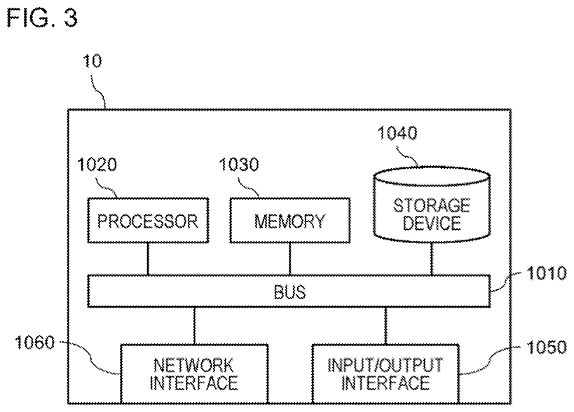

FIG. 3 is a diagram illustrating a hardware configuration example of the image processing apparatus 10. The image processing apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit/receive data to/from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage achieved by a random access memory (RAM) or the like.

The storage device 1040 is an auxiliary storage achieved by a hard disk drive (HDD), a solid state drive (SSD), a memory card, a read only memory (ROM), or the like. The storage device 1040 stores a program module that achieves each function (e.g., the image processing unit 110 and the execution unit 120) of the image processing apparatus 10. The processor 1020 reads each of the program modules onto the memory 1030, executes the read program module, and thereby achieves each function being related to the program module. Moreover, the storage device 1040 may also function as the data storage unit 130.

The input/output interface 1050 is an interface for connecting the image processing apparatus 10 and various pieces of input/output equipment with each other.

The network interface 1060 is an interface for connecting the image processing apparatus 10 to a network. The network is, for example, a local area network (LAN) or a wide area network (WAN). A method of connecting the network interface 1060 to a network may be wireless connection or may be wired connection. The image processing apparatus 10 communicates with the surveillance camera 20 and the external apparatus 30 via the network interface 1060.

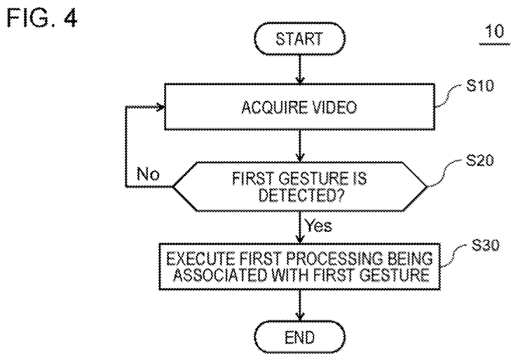

FIG. 4 is a flowchart illustrating one example of processing performed by the image processing apparatus 10. The image processing apparatus 10 performs processing illustrated in the present figure for each of videos generated by a plurality of the surveillance cameras 20.

The image processing unit 110 of the image processing apparatus 10 acquires a video from the surveillance camera 20. The video is preferably acquired in real time (step S10). Then, the image processing unit 110 of the image processing apparatus 10 processes the video acquired from the surveillance camera 20, and thereby determines whether a person included in the video performs a first gesture (step S20). In the processing, the image processing unit 110 uses information stored in the data storage unit 130.

Herein, the first gesture may be a specific pose, or may be a specific motion. In the former case, the image processing unit 110 determines presence/absence of a first gesture by use of one frame image. In the latter case, the image processing unit 110 determines presence/absence of a first gesture by use of a plurality of successive frame images. In this case, the first gesture may be, for example, performance of the same act (e.g., blinking) a predetermined number of times (e.g., 10 times) within a predetermined time (e.g., within 10 seconds), or may be continuation of a predetermined act (e.g., facing toward the surveillance camera 20) for equal to or more than a predetermined time (e.g., 10 seconds).

When the image processing unit 110 detects the first gesture (step S20: Yes), the execution unit 120 executes first processing being associated with the first gesture, by use of information stored in the data storage unit 130 (step S30). The first processing performed herein is, for example, notification processing for the external apparatus 30 or a state change of the notification unit 22 as described above, but is not limited thereto.

Herein, when the first processing is processing other than a state change of the notification unit 22, the execution unit 120 may change, after the first processing is completed, a state of the notification unit 22 of the surveillance camera 20 which is in front of a person who has performed the first gesture, to a predetermined state indicating that the first processing has been performed. In this way, the person in front of the surveillance camera 20 can recognize that the first processing has been performed.

As above, according to the present example embodiment, the image processing apparatus 10 processes a video generated by the surveillance camera 20, and thereby determines whether a person included in the video performs a previously determined first gesture. In the present example embodiment, a plurality of types of first gestures are determined, and first processing being associated with the first gesture is determined for each of the first gestures. Then, the image processing apparatus 10 executes first processing being associated with the detected first gesture. Thus, a person captured by the surveillance camera 20 can instruct the image processing apparatus 10 for various pieces of processing via the surveillance camera 20. Consequently, convenience of a user is enhanced.

Note that, in the present example embodiment, one piece of first processing may be associated with two or more first gestures. In this case, in the data storage unit 130, each of a plurality of pieces of first processing is associated with at least one first gesture.

### Second Example Embodiment

In the present example embodiment, an image processing apparatus 10 executes first processing on a necessary condition that a first gesture is detected, and then a second gesture is further detected. In a flowchart described later, detection of the first and second gestures is a necessary and sufficient condition for executing the first processing. The second gesture preferably differs from the first gesture, but may be the same as the first gesture.

In the present example embodiment, a data storage unit 130 stores information necessary for detecting the first gesture, similarly to the first example embodiment. Moreover, the data storage unit 130 stores information (e.g., a feature value of a pose of a person in an image, or transition thereof) necessary for detecting the second gesture, and information necessary for performing the first processing, in association with each other.

Note that, there may be only one first gesture, or may be a plurality of first gestures. Moreover, only one second gesture may be determined. In this case, there is one piece of first processing.

Moreover, for each of a plurality of types of second gestures, first processing being associated with the second gesture may be set. In this case, the data storage unit 130 stores, for each of a plurality of types of the second gestures, information (e.g., a feature value of a pose of a person in an image, or transition thereof) necessary for detecting the second gesture, and information necessary for performing the first processing being associated with the second gesture, in association with each other.

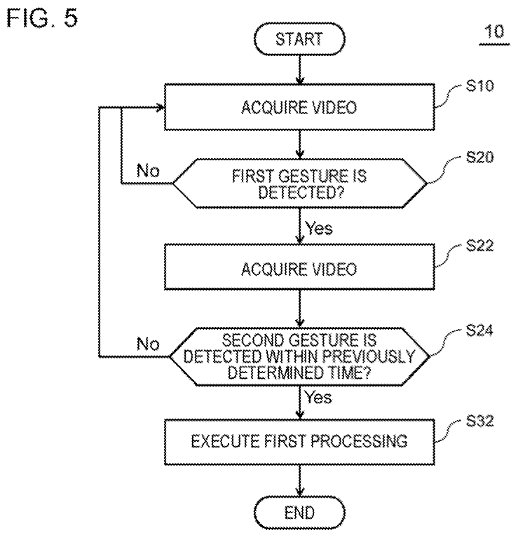

FIG. 5 is a flowchart illustrating one example of processing performed by the image processing apparatus 10 according to the present example embodiment. Processing performed in steps S10 and S20 is similar to that in the first example embodiment.

When a first gesture is detected (step S20: Yes), an image processing unit 110 of the image processing apparatus 10 performs preparation (e.g., processing of starting from a sleep state) for performing first processing. This is intended to quickly perform the first processing after second gesture is detected. Then, the image processing unit 110 further keeps acquiring a video (step S22), subsequently performs image processing, and determines whether a person performing the first gesture further performs the second gesture (step S24). When the second gesture is detected (step S24: Yes), an execution unit 120 executes the first processing (step S32).

Herein, when, for each of a plurality of types of second gestures, first processing being associated with the second gesture is set, the execution unit 120 executes, in step S32, first processing being associated with the second gesture detected in step S24.

Moreover, the execution unit 120 preferably determines, as a condition for executing first processing, that a time from detection of a first gesture to detection of a second gesture is a previously determined time (step S24). Herein, the previously determined time is, for example, equal to or more than one second and equal to or less than 30 seconds.

Herein, in the present example embodiment, after the image processing unit 110 detects a first gesture, the execution unit 120 may change a state of a notification unit 22 of a surveillance camera 20 which is in front of a person who has performed the first gesture, to a predetermined state indicating that preparation for performing first processing has been performed. In this way, a person captured by the surveillance camera 20 can recognize that the image processing apparatus 10 has performed preparation for performing the first processing.

Moreover, in the present example embodiment as well, when first processing is processing other than a state change of the notification unit 22, the execution unit 120 may change, after the first processing is completed, a state of the notification unit 22.

According to the present example embodiment, a person captured by the surveillance camera 20 is necessary to perform a first gesture and a second gesture in this order before the image processing apparatus 10 is caused to perform first processing. Thus, a possibility that the image processing apparatus 10 erroneously performs first processing decreases. Consequently, convenience of the image processing apparatus 10 is enhanced. Herein, when it is required, as a condition for executing first processing, that a time from detection of a first gesture to detection of a second gesture is a previously determined time, a possibility that the image processing apparatus 10 erroneously performs first processing further decreases.

### Third example embodiment

An image processing apparatus 10 according to the present example embodiment is similar in configuration to the image processing apparatus 10 according to the first or second example embodiment, except that first processing is executed on a necessary condition that a person performing a first gesture (and a second gesture) is a previously determined person.

For example, when a surveillance camera 20 is a surveillance camera of a bank or a store, a previously determined person is a clerk of the store or a bank clerk of the bank. In this case, whether a person is a previously determined person is determined by, for example, face recognition. Moreover, when the surveillance camera 20 is located outside a building (e.g., in a city), a previously determined person is a police officer. In this case, whether a person is a police officer may be determined by, for example, clothes.

In the present example embodiment, a storage unit 130 stores a feature value of a previously determined person. The image processing unit 110 determines, by use of information stored in the data storage unit 130, whether a person performing a first gesture (and a second gesture) is a previously determined person.

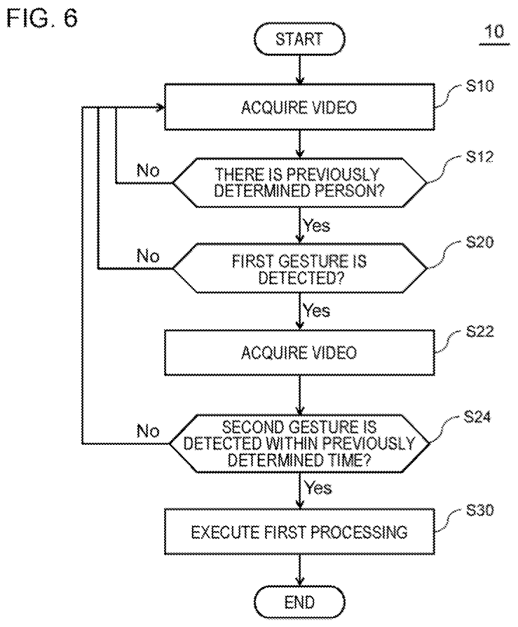

FIG. 6 is a flowchart illustrating one example of processing performed by the image processing apparatus 10 in the present example embodiment. In the present example embodiment, when a video is acquired (step S10), the image processing unit 110 of the image processing apparatus 10 determines whether there is a previously determined person in the image (step S12). When there is a previously determined person, processing in and after step S20 is performed for the person.

Note that, FIG. 6 is based on FIG. 5. However, processing illustrated in step S12 in the present figure may be performed between step S10 and step S20 in FIG. 4.

According to the present example embodiment, first processing is not performed even when a person other than a previously determined person performs a first gesture (and a second gesture). Thus, a possibility that first processing is erroneously performed decreases.

While the example embodiments of the present invention have been described above by use of the drawings, the example embodiments are exemplifications of the present invention, and various configurations other than those described above can also be adopted.

Moreover, although a plurality of steps (pieces of processing) are described in order in a plurality of flowcharts used in the above description, an execution order of steps executed in each example embodiment is not limited to the described order. In each example embodiment, an order of illustrated steps can be changed to an extent that causes no problem in terms of content. Moreover, each example embodiment described above can be combined as far as contents do not contradict.

Some or all of the above-described example embodiments can also be described as, but are not limited to, the following supplementary notes.

1. An image processing apparatus including:

an image processing unit that processes a video generated by a surveillance camera, and thereby determines whether a person included in the video performs a first gesture; and

an execution unit that executes first processing on a necessary condition that the first gesture is detected, wherein

a plurality of types of the first gestures exist,

the first processing is determined for each of a plurality of types of the first gestures, and

the execution unit executes the first processing being associated with a type of the detected first gesture.

2. An image processing apparatus including:

an image processing unit that processes a video generated by a surveillance camera, and thereby determines whether a person included in the video performs a first gesture; and

an execution unit that executes first processing on a necessary condition that the first gesture is detected, wherein,

after the first gesture is detected, the image processing unit determines whether the person further performs a second gesture, and,

when the second gesture is detected, the execution unit executes the first processing.

3. The image processing apparatus according to supplementary note 2, wherein

a plurality of types of the second gestures exist,

the first processing is determined for each of a plurality of types of the second gestures, and

the execution unit executes the first processing being associated with a type of the detected second gesture.

4. The image processing apparatus according to supplementary note 2 or 3, wherein,

when the second gesture is detected within a previously determined time after the first gesture is detected, the execution unit executes the first processing.

5. The image processing apparatus according to any one of supplementary notes 2 to 4, wherein,

after the first gesture is detected, the execution unit changes a state of a notification unit provided in the surveillance camera or in a vicinity of the surveillance camera.

6. The image processing apparatus according to any one of supplementary notes 1 to 5, wherein

the first processing is notification processing for an external apparatus.

7. The image processing apparatus according to any one of supplementary notes 1 to 6, wherein,

after the first processing is finished, the execution unit changes a state of a notification unit provided in the surveillance camera or in a vicinity of the surveillance camera.

8. The image processing apparatus according to any one of supplementary notes 1 to 5, wherein

the first processing is changing a state of a notification unit provided in the surveillance camera or in a vicinity of the surveillance camera.

9. The image processing apparatus according to any one of supplementary notes 1 to 8, wherein

the image processing unit determines whether the person is a previously determined person, and

the execution unit executes first processing on a necessary condition that the person is the previously determined person.

10. An image processing method including,

performing by a computer:
image processing of processing a video generated by a surveillance camera, and thereby determining whether a person included in the video performs a first gesture; and
execution processing of executing first processing on a necessary condition that the first gesture is detected, wherein

a plurality of types of the first gestures exist,

the first processing is determined for each of a plurality of types of the first gestures, and,

in the execution processing, the computer executes the first processing being associated with a type of the detected first gesture.

11. An image processing method including,

performing by a computer:
image processing of processing a video generated by a surveillance camera, and thereby determining whether a person included in the video performs a first gesture; and
execution processing of executing first processing on a necessary condition that the first gesture is detected, wherein,

in the image processing, after the first gesture is detected, the computer determines whether the person further performs a second gesture, and,

in the execution processing, when the second gesture is detected, the computer executes the first processing.

12. The image processing method according to supplementary note 11, wherein

a plurality of types of the second gestures exist,

the first processing is determined for each of a plurality of types of the second gestures,

the image processing method further including,

by the computer,

in the execution processing, executing the first processing being associated with a type of the detected second gesture.

13. The image processing method according to supplementary note 11 or 12, further including,

by the computer,

in the execution processing, when the second gesture is detected within a previously determined time after the first gesture is detected, executing the first processing.

14. The image processing method according to any one of supplementary notes 11 to 13, further including,

by the computer,

in the execution processing, after the first gesture is detected, changing a state of a notification unit provided in the surveillance camera or in a vicinity of the surveillance camera.

15. The image processing method according to any one of supplementary notes 10 to 14, wherein

the first processing is notification processing for an external apparatus.

16. The image processing method according to any one of supplementary notes 10 to 15, further including, by the computer,

in the execution processing, after the first processing is finished, changing a state of a notification unit provided in the surveillance camera or in a vicinity of the surveillance camera.

17. The image processing method according to any one of supplementary notes 10 to 14, wherein

the first processing is changing a state of a notification unit provided in the surveillance camera or in a vicinity of the surveillance camera.

18. The image processing method according to any one of supplementary notes 10 to 17, further including,

by the computer:

in the image processing, determining whether the person is a previously determined person; and

in the execution processing, executing first processing on a necessary condition that the person is the previously determined person.

19. A program causing a computer to include:

an image processing function of processing a video generated by a surveillance camera, and thereby determining whether a person included in the video performs a first gesture; and

an execution function of executing first processing on a necessary condition that the first gesture is detected, wherein

a plurality of types of the first gestures exist,

the first processing is determined for each of a plurality of types of the first gestures, and

the execution function executes the first processing being associated with a type of the detected first gesture.

20. A program causing a computer to include:

an image processing function of processing a video generated by a surveillance camera, and thereby determining whether a person included in the

video performs a first gesture; and an execution function of executing first processing on a necessary condition that the first gesture is detected, wherein,

after the first gesture is detected, the image processing function determines whether the person further performs a second gesture, and,

when the second gesture is detected, the execution function executes the first processing.

21. The program according to supplementary note 20, wherein

a plurality of types of the second gestures exist,

the first processing is determined for each of a plurality of types of the second gestures, and

the execution function executes the first processing being associated with a type of the detected second gesture.

22. The program according to supplementary note 20 or 21, wherein,

when the second gesture is detected within a previously determined time after the first gesture is detected, the execution function executes the first processing.

23. The program according to any one of supplementary notes 20 to 22, wherein,

after the first gesture is detected, the execution function changes a state of a notification unit provided in the surveillance camera or in a vicinity of the surveillance camera.

24. The program according to any one of supplementary notes 19 to 23, wherein

the first processing is notification processing for an external apparatus.

25. The program according to any one of supplementary notes 19 to 24, wherein,

After the first processing is finished, the execution function changes a state of a notification unit provided in the surveillance camera or in a vicinity of the surveillance camera.

26. The program according to any one of supplementary notes 19 to 23, wherein

the first processing is changing a state of a notification unit provided in the surveillance camera or in a vicinity of the surveillance camera.

27. The program according to any one of supplementary notes 19 to 26, wherein

the image processing function determines whether the person is a previously determined person, and

the execution function executes first processing on a necessary condition that the person is the previously determined person.

### REFERENCE SIGNS LIST

10 Image processing apparatus
20 Surveillance camera
30 External apparatus
110 Image processing unit
120 Execution unit
130 Data storage unit

What is claimed is:

1. An image processing apparatus comprising:
at least one memory configured to store instructions; and
at least one processor configured to execute the instructions to preform operations comprising:
processing a video generated by a surveillance camera, and thereby determining whether a person included in the video performs a first gesture; and
executing first processing on a necessary condition that the first gesture is detected, wherein
a plurality of types of the first gestures exist,
the first processing is determined for each of a plurality of types of the first gestures, and
the first processing to be executed is identified based on a type of the detected first gesture.

2. An image processing apparatus comprising:
at least one memory configured to store instructions; and
at least one processor configured to execute the instructions to preform operations comprising:
processing a video generated by a surveillance camera, and thereby determining whether a person included in the video performs a first gesture; and
executing first processing on a necessary condition that the first gesture is detected, wherein the operations further comprise, after the first gesture is detected, determining whether the person further performs a second gesture, and,
when the second gesture is detected, executing the first processing.

3. The image processing apparatus according to claim 2, wherein
a plurality of types of the second gestures exist,
the first processing is determined for each of a plurality of types of the second gestures, and
the first processing to be executed is identified based on a type of the detected second gesture.

4. The image processing apparatus according to claim 2, wherein the operations further comprise,
when the second gesture is detected within a previously determined time after the first gesture is detected, executing the first processing.

5. The image processing apparatus according to claim 2, wherein the operations further comprise,
after the first gesture is detected, changing a state of notification output from a device provided in the surveillance camera or in a vicinity of the surveillance camera.

6. The image processing apparatus according to claim 1, wherein
the first processing is notification processing for an external apparatus.

7. The image processing apparatus according to claim 1, wherein the operations further comprise,
after the first processing is finished, changing a state of notification output from a device provided in the surveillance camera or in a vicinity of the surveillance camera.

8. The image processing apparatus according to claim 1, wherein
the first processing is changing a state of notification output from a device provided in the surveillance camera or in a vicinity of the surveillance camera.

9. The image processing apparatus according to claim 1, wherein the operations further comprise
determining whether the person is a previously determined person, and
executing first processing on a necessary condition that the person is the previously determined person.

10. (Canceled)

11. An image processing method comprising,
performing by a computer:
image processing of processing a video generated by a surveillance camera, and thereby determining whether a person included in the video performs a first gesture; and
execution processing of executing first processing on a necessary condition that the first gesture is detected, wherein,
in the image processing, after the first gesture is detected, the computer determines whether the person further performs a second gesture, and,
in the execution processing, when the second gesture is detected, the computer executes the first processing.

12. (canceled)

13. A non-transitory computer-readable medium storing a program for causing a computer to perform operations comprising:
processing a video generated by a surveillance camera, and thereby determining whether a person included in the video performs a first gesture; and
executing first processing on a necessary condition that the first gesture is detected, wherein the operations further comprise,
after the first gesture is detected, determining whether the person further performs a second gesture, and,
when the second gesture is detected, executing the first processing.
